(19) United States
(12) Patent Application Publication
(10) Pub. No.: US 2025/0118940 A1
(43) Pub. Date: Apr. 10, 2025

(54) ELECTRICAL CONNECTOR HOUSING HAVING CUT BLADE AND METHOD OF USING THE SAME

(71) Applicant: Robert W. SULLIVAN, Simi Valley, CA (US)

(72) Inventor: Robert W. SULLIVAN, Simi Valley, CA (US)

(21) Appl. No.: 18/886,750

(22) Filed: Sep. 16, 2024

Related U.S. Application Data
(60) Provisional application No. 63/542,408, filed on Oct. 4, 2023.

(51) Int. Cl. H01R 24/64; H01R 13/415; H01R 13/50; H01R 43/01; H01R 43/22

(52) U.S. Cl. CPC H01R 24/64; H01R 13/415; H01R 13/50; H01R 43/015; H01R 43/22; H01R 2201/04

(57) ABSTRACT

An electrical connector housing is provided. A slot is provided in the housing between a plurality of contact blades and the front surface of the electrical connector housing. The slot extends perpendicularly from the top surface of the electrical connector housing to communicate with a plurality of passages in the housing for receiving insulated wires. A cutting blade is received and secured in the slot for cutting portions of the insulated wires that exceed the slot or the cutting blade in the lengthwise direction of the electrical connector housing. The housing is able to prevent electrical shorts, sparks and other electrical risks arising from exposed or open wire ends on the connector.

### CROSS-REFERENCE TO RELATED APPLICATION

This application claims the benefit of provisional U.S. Application No. 63/542,408 filed on 4 Oct. 2023, the entire contents of which are incorporated herein and made a part of this specification.

### TECHNICAL FIELD

The present disclosure relates to an electrical connector housing and its method of use, in particular, an electrical connector housing having cut blade(s) therein and a method of using the same for making an electrical connector.

### BACKGROUND

As electrical components for high-speed data transmission are made more intricate and specialized, the corresponding wires get assigned more specifications and inherit more rigorous demands. It has become necessary to establish rigorous standards for their performance while increasing the applications and performance of these connectors. Precise configurations and dimensions are required by Federal Communications Commission (FCC) regulations and other industry standards such as Power Over Ethernet (POE) and the IEEE 802.3 standard, also known as Alternative B mode. An electrical connector housing must be made of a moldable material such as plastic which is sufficiently moldable and deformable to capture and retain the wires inside it while insulating the internal electrical flow and maintaining precise dimensions. At the same time, there must be sufficient rigidity to reliably support the wires and their associated contact pin elements in precisely the correct positions, ensuring they can properly mate with associated system components. A further requirement is the moldable material which ensures the wires can be sufficiently and effectively cut off and terminated. An upcoming and crucial requirement is that each wire's insulation must isolate individual conductors, and the connector must ensure there is no short circuiting or continuity path from one wire to another wire or to adjacent hardware and wires. Another requirement is the insulation and isolation of each conductor from adjacent conductors and external paths of continuity. The insulation and isolation should be sufficient to prevent any electrical current from flowing between conductors or to external paths. Furthermore, the insulation should be durable and resistant to wear and tear over time. For example, there is a product known as Simply45 Cap Isolation Caps (see U.S. Pat. No. 10,811,831), which is an isolation cap/bar that attaches onto the connector covering the exposed wires after termination to prevent electrical shorts, sparks and other electrical risks arising from exposed or open wire ends on the connector.

Thus, it is desirable for the construction, electrical and electronic industries to provide an electrical connector housing that insulates the wires and reduces the need for an extra cap or ancillary protective measure as described in U.S. Pat. No. 10,811,831, to eliminate sparks or electrical migration onto parallel, coaxial, near, or adjacent conducting materials while meeting FCC regulations and POE standards.

### SUMMARY

To overcome the aforementioned problem, the inventor, Robert W Sullivan, in this disclosure, makes improvements to his previous inventions in U.S. Pat. No. 5,996,224; 6,017,237; 6, 105,229; 9,543,729; 10,116,082; 10,573,990 and 11,146,014. For more than 20 years, the eight-wire connector system disclosed in the above referenced patents have been sold under the trademark EZ-RJ45 and used in Ethernet cable systems throughout the industry. This disclosure aims to modify the EZ-RJ45 connector to achieve a reliable connection under comparatively harsh or extreme environmental conditions.

In one embodiment of this disclosure, an electrical connector housing is provided, which has a front-end wall in which horizontal holes or openings are formed. The housing has a cutting blade therein for eliminating the overflow of the connector wires and is positioned away from the front end of the connector. Space and guides are provided for the cutting blade, which is integral to the connector. The wires are supported within the connector in a small confide, and the excess wires are cut within the connector. After being cut off, the excess wires are forcibly removed from the front of the connector, thus insulating the cut ends of the wires from shorting out, sparking, or smearing against each other, having exposed copper, or making contact with a corresponding wire. The conductors in the wires are spaced away from the front of the electrical connector housing by being cut out or internally positioned from the front mating end. This allows for the isolation of the conductor after cut and termination, and eliminates the need for extra hardware or secondary operation with a cap/bar system. The distal sheared ends of the exposed wires are safely distanced from the end of the connector; the protruding wires are deliberately and uniformly discarded. The electrical connector housing fits correctly within its allotted space in an associated terminal board per FCC regulations and POE requirements without the concern for excessive wire end protrusions.

In one embodiment of this disclosure, the contact plate/pins/blades and the cutting blades are bound, stamped, or manufactured together, forming an integral unit. They are crimped, and the wires are cut off simultaneously by the connector's cutting blades. In another embodiment, the contact plate/pin/blades are separated from the cutting blades, and the cutting blade cuts the insulated wires in a serial fashion. In a further embodiment, a separate outside blade is provided to cut the insulated wires through a slot in the electrical connector housing. All embodiments excel at cutting off excess insulated wires while the electrical connector housing is being crimped and exposed cut wire ends insulated and protected. During the crimping process, the contacts blades are being forced into conductive engagement with the associated wires.

With the cutting blade disposed in the electrical connector housing, a user can reduce the need for a cutting tool which requires an expensive cutting blade or the costly replacement of the cutting blade when it becomes dull. Additionally, the internal cutting blade is configured to cut off all the protruding wire ends concurrently or in a sequential manner during the crimping operation, without needing an expensive external cutting blade or modification of a cutting/crimping tool and reducing the need for secondary operations.

In a further embodiment, a guideway is vertically provided inside the electrical connector housing that permits two horizontal or flat rows of wires to be inserted into and through the front wall of the housing. In operation, a tool seats the contact plates/pins/blades into the housing to crimp the insulated wires and then, by a secondary step, a cutting blade is driven to cut off excess wires through the guideway. Alternatively, the tool drives down the contact plates/pins/blades along with the cutting blade so that the contact blades and the wires are crimped and the excess portions of the wires are cut off. These improvements aim to provide a connector suitable for CAT 6A Ethernet cable and CAT6-type transmissions with POE and reduce the adverse effects of shorts, sparks, and cross-conduction to other undesirable contacts.

Given the above, advantages brought by this disclosure include: (1) the wires are arranged inside the connector in such a way as to minimize interference or crosstalk between data streams being transmitted on respective wire pairs; (2) allows for faster data transmission while reducing the amount of energy needed; the wires are also insulated to prevent electrical shorts and to protect against corrosion. In addition, in the above embodiments, color-coded wires inserted into the connector are allowed to protrude out from its front end so that a technician may view the color-coded wires to confirm their correct relative positions before cutting them off. Furthermore, the driven engagement of metallic contact plate/pins/blades with the wires, and the cutting off of the wires, can be done concurrently or in series. This makes the process of connecting and cutting wires faster and more efficient. Furthermore, it eliminates the need for a separate cutting tool and makes the connection more secure.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic view showing a first embodiment of the present disclosure.

FIG. 2 is a schematic view showing a tool being used to cut off a portion of the insulated wires in the first embodiment.

FIG. 3 is a schematic view showing a tool being used to cut off and crimp the insulated wires in a second embodiment.

FIG. 4 is a schematic view showing the contact blades being pressed downward first, and a tool is then used to cut off a portion of the insulated wires in a second embodiment.

FIG. 5 is a schematic view showing the portion of the insulated wire having been cut off from the second embodiment.

FIG. 6 is a schematic front view of the first embodiment shown in FIG. 1.

FIG. 7 is a schematic front view of the second embodiment shown in FIG. 3.

FIG. 8 is a schematic front view of a third embodiment of the present disclosure.

FIG. 9A is a schematic view showing the cutting blade contacting the contact blade.

FIG. 9B is a regionally enlarged view of portion A in FIG. 3.

### DETAILED DESCRIPTION OF THE DISCLOSURE

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In some embodiments, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass orientations of the device in use or operation in some embodiments different from the orientation depicted in the figures. The apparatus may be otherwise oriented (rotated 90 degrees or at other orientations) and the spatially relative descriptors used herein may likewise be interpreted accordingly.

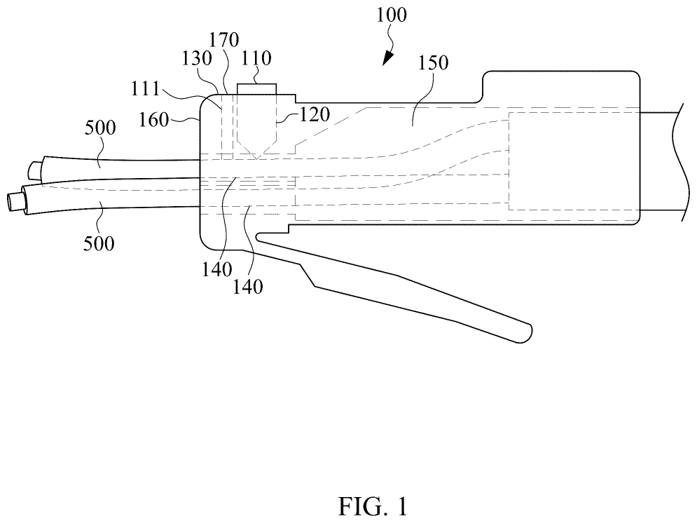

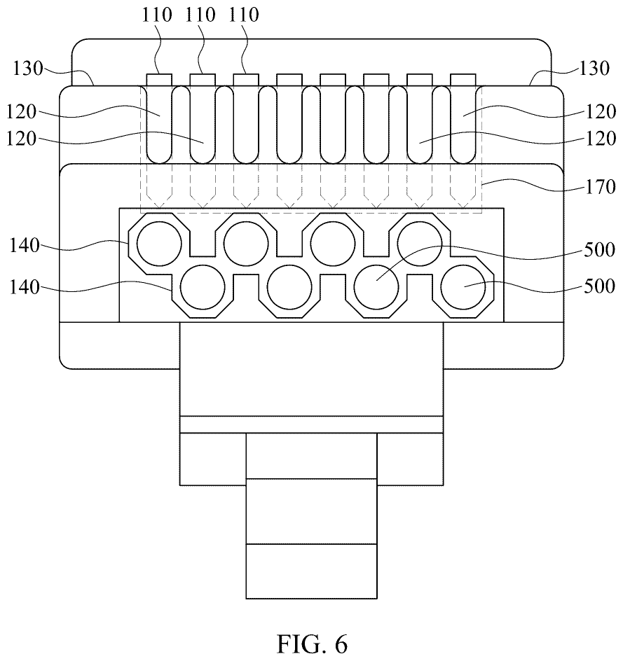

As shown in FIGS. 1 and 6, in the first embodiment of the instant disclosure, an electrical connector housing 100 is provided. The electrical connector housing 100 comprises a plurality of contact blades 110, each received in a groove 120 formed in a top surface 130 of the electrical connector housing 100. A plurality of passages 140 are formed inside the electrical connector housing 100 and located below the plurality of contact blades 120. Each of the passages 140 communicates with a rear opening 150 and extends through a front surface 160 of the electrical connector housing 100. In the electrical connector housing 100, a slot 170 is formed between the plurality of the contact blades 110 and the front surface 160 of the electrical connector housing 100 in the lengthwise direction of the electrical connector housing 100. The slot 170 extends perpendicularly from the top surface 130 of the electrical connector housing 100 to communicate with each of the plurality of passages 140.

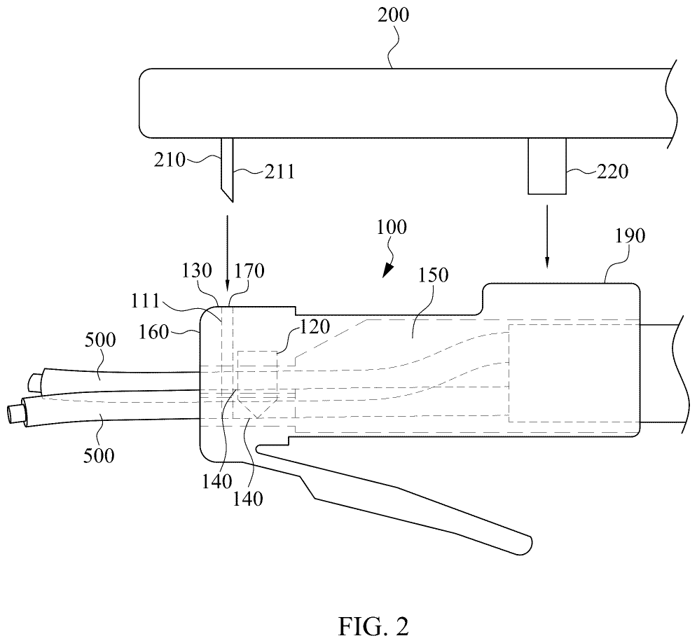

Please refer to FIG. 2. The slot 170 is configured to receive a cutting blade 210 of a cutting tool 200 in a first position in which a tip 211 of the cutting blade 210 is not in the plurality of the passages 140 and in a second position in which the tip 211 of the cutting blade 210 is in the plurality of the passages 140. As shown in FIG. 2, the slot 170 is spaced apart from the plurality of the contact blades 110 in the lengthwise direction of the electrical connector housing 100. Under this arrangement, the contact blades 110 may be pressed down through a tool (not shown), first as shown in FIG. 2, and then a user may need to push the cutting tool 200 with the cutting blade 210 from the first position down to the second position so that the cutting blade 210 cuts off insulated wires 500 in the passages 140, and the tip 211 of the cutting tool 200 is in the plurality of the passages 140. As shown in FIG. 2, a crimping portion 220 is used to crimp a rear portion 190 of the electrical connector housing 100 so that the rear portion 190 of the electrical connector housing 100a tightly holds the insulated wires 500. In some embodiments of this disclosure, the left sides 111 of the contact blades 110 are generally flush with a side of the slot 170, and the left sides of the contact blades 110 are exposed to the slot 170.

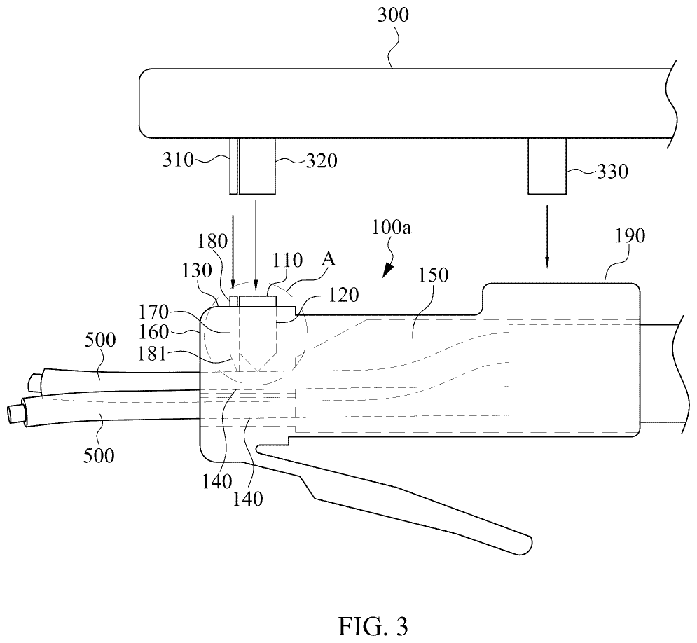

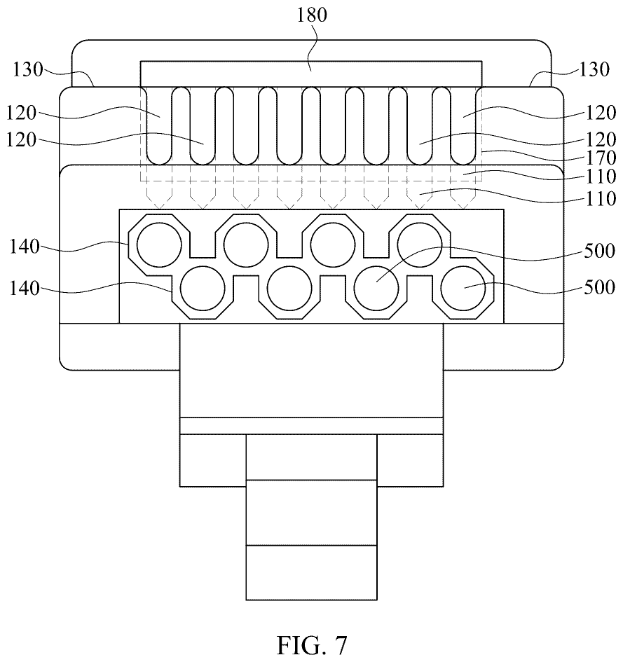

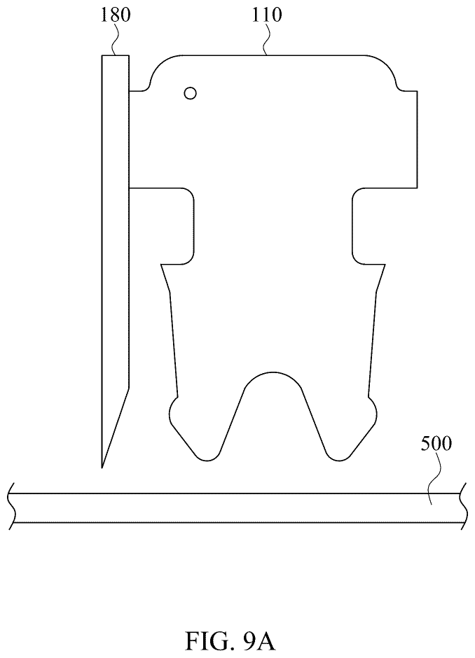

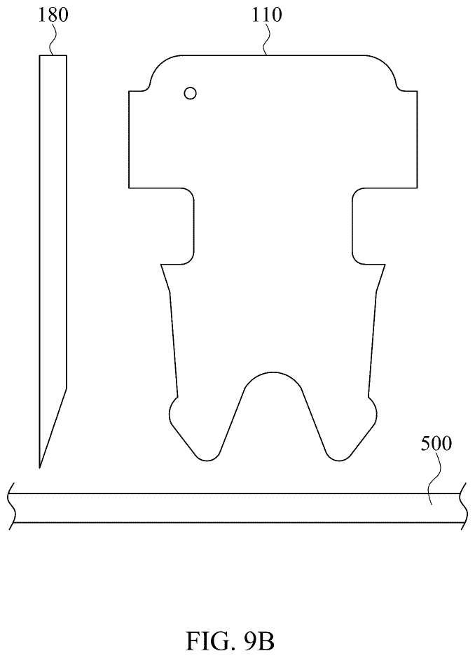

As shown in FIGS. 3 and 7, in the second embodiment of this disclosure, an electrical connector housing 100a is provided. The electrical connector housing 100a has the structures similar to those of the electrical connector housing 100a shown in FIG. 1, and further comprises a cutting blade 180 received and held in the slot 170 wherein the cutting blade 180 is movable in a first position in which a tip 181 of the cutting blade 180 is not in the plurality of the passages 140, and in a second position in which the tip 181 of the cutting blade 180 is in the plurality of the passages 140. In some embodiments of this disclosure, the cutting blade 180 is directly embedded in the electrical connector housing 100a in a location identical to that of the cutting blade 180 shown in FIG. 3. As shown in FIG. 3, the cutting blade 180 is spaced apart from the plurality of the contact blades 120 in a lengthwise direction of the electrical connector housing 100a. FIG. 9B shows a regionally enlarged portion A in FIG. 3. The shape of the contact blades 120 in FIG. 9B reflects an actual shape of the contact blades, while that shown in FIG. 3 is shown for illustrative purposes. In some embodiments of this disclosure, the cutting blade 180 contacts the plurality of the contact blades 120 in a lengthwise direction of the electrical connector housing 100a. Please refer to FIG. 9A, which shows the details of such arrangement. In some embodiments of this disclosure, the cutting blade 180 is a single cutting blade and is made of hard plastic or ceramic that is sufficiently hard for cutting insulated wires 500. The single cutting blade 180 may also be made of any other non-conductive materials that are sufficiently hard for cutting insulated wires 500. In some embodiments of this disclosure, the cutting blade 180 and contact blade 110 is a single cutting and seating entity that is sufficiently hard for cutting insulated wires 500 and seating onto wires 500. The single cutting blade tip 181 may also be made with an other non-conductive materials or coating that are sufficiently hard for cutting insulated wires 500 and insulating the cut end.

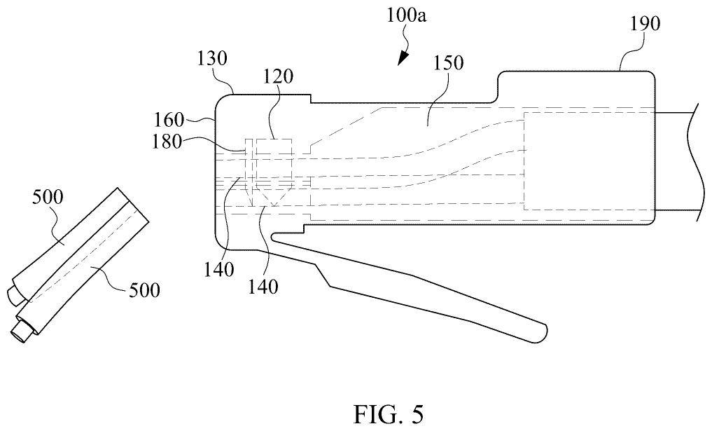

In one operation of the electrical connector housing 100a, as shown in FIG. 3, a crimping tool 300 is provided. The crimping tool 300 comprises a first portion 310, a second portion 320 and a third portion 330 attached to the body of the crimping tool 300. When a user pushes down the crimping tool 300, the first portion 310 abuts against the top of the cutting blade 180 and concurrently the second portion 320 abuts against the top of the contact blades 110. Consequently, as shown in FIG. 5, the contact blades 110 move downward and pierce through the insulated layers of the insulated wires to make electrical connections between the contact blades 110 and the insulated wires 500, and the cutting blade 180 moves downward to cut off portions of the insulated wires 500 that protrude beyond the slot 170 or the cutting blade 180. The portions being cut off are removed from the front of the electrical connector housing 100a, thereby insulating the cut end of the wires 500 from shorting out, sparking, or smearing against each other, having exposed copper, or making contact with a corresponding wire. The third portion 330 then crimps a rear portion 190 of the electrical connector housing 100a so that the rear portion 190 of the electrical connector housing 100a tightly holds the insulated wires 500.

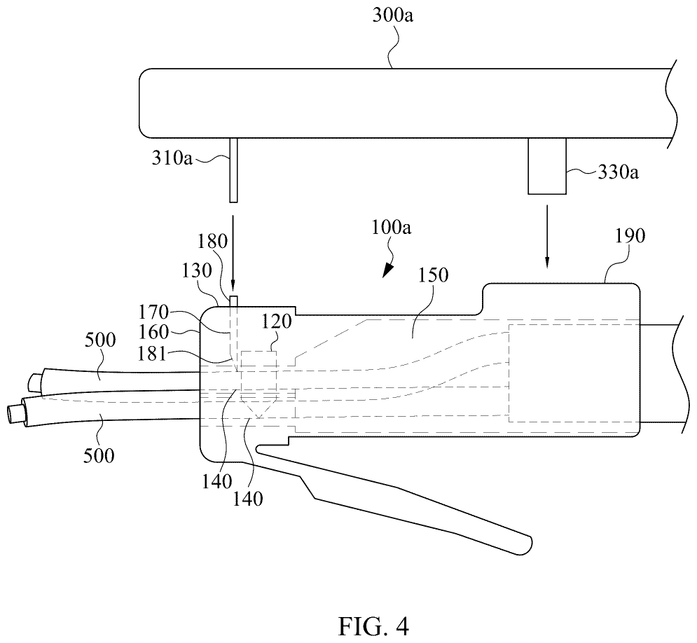

As shown in FIG. 4, in another operation of the electrical connector housing 100a, a crimping tool 300a is provided. The crimping tool 300a comprises a first portion 310a and a second portion 330 attached to the body of the crimping tool 300a. In this operation, the contact blades 110 may be pressed down through a tool (not shown) first to pierce through the insulated layers of the insulated wires and to make electrical connections between the contact blades 110 and the insulated wires 500 as shown in FIG. 4, and then the crimping tool 300 is pushed down. Consequently, the cutting blade 180 moves downward to cut off the portions of the insulated wires 800 that protrude beyond the slot 170 or the cutting blade 180 (see FIG. 5). The second portion 330a crimps a rear portion 190 of the electrical connector housing 100a so that the rear portion 190 of the electrical connector housing 100a tightly holds the insulated wires 500.

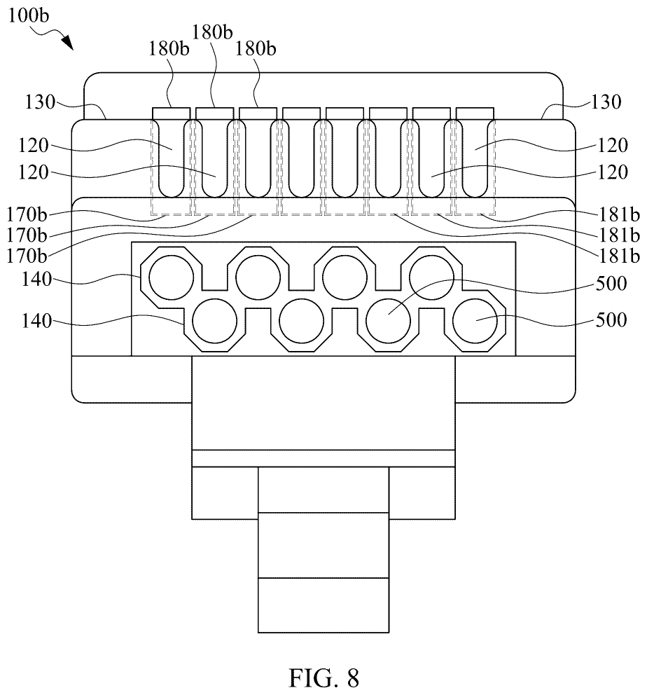

In the third embodiment of this disclosure as shown in FIG. 8, an electrical connector housing 100b is provided. The passages 140 are arranged in two rows and are partially merged. The plurality of cutting blades 180b are made of metal, such as steel. The electrical connector housing 100b has structures similar to those of the electrical connector housing 100a shown in FIGS. 2 and 7. The electrical connector housing 100b differs from the electrical connector housing 100a in that the latter has a single cutting blade 180 while the former has a plurality of cutting blades 180b received in a plurality of thin slots 170b, each positioned with the corresponding one of the passages 140, wherein the cutting blades 180b are spaced apart from each other and are movable in a first position in which tips 181b of the cutting blades 180b are not in the plurality of the passages 140, and in a second position in which the tips 181b of the cutting blade 180b are in the plurality of the passages 140. In some embodiments, the cutting blades 180b are spaced apart from the plurality of the contact blades 110 in a lengthwise direction of the electrical connector housing 100b. In some other embodiments, the cutting blades 180b respectively contact the plurality of the contact blades 110 in a lengthwise direction of the electrical connector housing 100b.

In one embodiment of this disclosure, a method of making an electrical connector is provided. The method includes the following steps: (a) providing an electrical connector housing 100 of the first embodiment (see FIG. 1); (b) providing a tool 200 having a cutting blade 210; (c) inserting each of a plurality of insulated wires 500 from the rear opening 150 of the electrical connector housing 100, and passing it 500 through the corresponding passage 140 to protrude beyond the slot 170; (d) pressing the contact blades 110 of the electrical connector housing 100 with a crimping tool (not shown) so that the contact blades 110 of the electrical connector housing 100 move downward and pierce through the insulated layers of the insulated wires 500 to make electrical connections between the contact blades 110 and the insulated wires 500; and (c) and pressing the cutting blade 210 of the tool 200 into the slot 170 of the electrical connector housing 100 so that the cutting blade 210 moves downward to cut off the portions of the insulated wires 500 that protrude beyond the slot 170 in the lengthwise direction of the electrical connector housing 100. During step (c), the crimping portion 220 of the tool 200 is concurrently moved downward to crimp a rear portion 190 of the electrical connector housing 100 so that the rear portion 190 of the electrical connector housing 100a tightly holds the insulated wires 500.

In one embodiment of this disclosure, another method of making an electrical connector is provided. The method includes the following steps: (a) providing an electrical connector housing 100 of the second embodiment (see FIG. 3); (b) inserting each of a plurality of insulated wires 500 from the rear opening 150 of the electrical connector housing 100a, and passing each wire 500 through the corresponding passage 140 to protrude beyond the slot 170 or the cutting blade 180; and (c) as shown in FIGS. 3 and 5, concurrently pressing the contact blades 110 and the cutting blade 180 of the electrical connector housing 100a so that the contact blades 110 move downward and pierce through the insulated layers of the insulated wires 500 to make electrical connections between the contact blades 110 and the insulated wires 500, and the cutting blade 180 moves downward to cut off the portions of the insulated wires 500 that protrude beyond the slot 170 or the cutting blade 180. The cut blade may or may not be made as one part with the contact blade or as individual subsets of a unit or external to the electrical connector housing.

In one embodiment of this disclosure, a further method of making an electrical connector is provided. The method includes the following steps: (a) providing an electrical connector housing 100b of the third embodiment (see FIG. 8); (b) inserting each of a plurality of insulated wires 500 from the rear opening 150 of the electrical connector housing 100b, and passing each wire 500 through the corresponding passage 140 to protrude beyond the thin slots 170b or the cutting blades 180b; and (c) concurrently pressing the contact blades 110 and the plurality of cutting blades 180b of the electrical connector housing 100b so that the contact blades 110 move downward and pierce through the insulated layers of the insulated wires 500 to make electrical connections between the contact blades 180b and the insulated wires 500, and the plurality of cutting blades 180b moves downward to correspondingly cut off the portions of the insulated wires 500 that protrude beyond the thin slots 170b or the cutting blades 180b. The portions being cut off are removed from the front of the electrical connector housing 100b, thus insulating the cut end of the wires 500 from shorting out, sparking, or smearing against each other, having exposed copper, or making contact with a corresponding wire.

Notwithstanding that the numerical ranges and parameters set forth in the broad scope of the disclosure are approximations, the numerical values set forth in the specific examples arc reported as precisely as possible. Any numerical value, however, inherently contains certain errors necessarily resulting from the standard deviation found in the respective testing measurements. Also, as used herein, the terms “substantially,” “approximately,” or “about” generally mean within a value or range which can be contemplated by people having ordinary skill in the art. Alternatively, the terms “substantially,” “approximately,” or “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately,” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless otherwise specified.

The foregoing outlines features of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, compositions of matter, means, methods and steps described in the specification. As one of ordinary skill in the art will readily appreciate from the disclosure of the present invention, processes, machines, manufacture, compositions of matter, means, methods or steps, presently existing or later to be developed, that perform substantially the same function or achieve substantially the same result as the corresponding embodiments described herein, may be utilized according to the present invention. Accordingly, the appended claims are intended to include within their scope such processes, machines, manufacture, compositions of matter, means, methods and steps.

1. An electrical connector housing comprising:
a plurality of contact blades, each received in a groove formed in a top surface of the electrical connector housing;
a plurality of passages formed inside the electrical connector housing and located below the plurality of contact blades, each passage communicating with a rear opening and extending through a front surface of the electrical connector housing; and
a slot formed between the plurality of the contact blades and the front surface of the electrical connector housing, the slot extending perpendicularly from the top surface of the electrical connector housing to communicate with each of the plurality of passages.

2. The electrical connector housing of claim 1, wherein the slot is configured to receive a cutting blade of a cutting tool in a first position in which a tip of the cutting blade is not in the plurality of the passages, and in a second position in which the tip of the cutting blade is in the plurality of the passages.

3. The electrical connector housing of claim 2, wherein the slot is spaced apart from the plurality of the contact blades in a lengthwise direction of the electrical connector housing.

4. The electrical connector housing of claim 2, wherein the sides of the contact blades that face toward the front surface are substantially flush with a side of the slot and the sides of the contact blades are exposed to the slot.

5. The electrical connector housing of claim 1, further comprising a cutting blade received in the slot, wherein the cutting blade is movable in a first position in which a tip of the cutting blade is not in the plurality of the passages, and in a second position in which the tip of the cutting blade is in the plurality of the passages.

6. The electrical connector housing of claim 5, wherein the cutting blade is spaced apart from the plurality of the contact blades in a lengthwise direction of the electrical connector housing.

7. The electrical connector housing of claim 5, wherein the cutting blade contacts the plurality of the contact blades in a lengthwise direction of the electrical connector housing.

8. The electrical connector housing of claim 5, wherein the cutting blade is a single cutting blade and is made of metal, hard plastic or ceramic that is sufficiently hard for cutting insulated wires.

9. The electrical connector housing of claim 1, wherein the passages are arranged in a lower row and an upper row and are alternating in the two rows, and the slot comprises a plurality of thin slots, the electrical connector housing further comprising a plurality of cutting blades received in the thin slots, each positioned with the corresponding one of the passages, wherein the cutting blades are spaced apart from each other and are movable in a first position in which tips of the cutting blades are not in the plurality of the passages, and in a second position in which the tips of the cutting blade are in the plurality of the passages.

10. The electrical connector housing of claim 9, wherein the cutting blades are spaced apart from the plurality of the contact blades in a lengthwise direction of the electrical connector housing.

11. The electrical connector housing of claim 9, wherein the cutting blades respectively contact the plurality of the contact blades in a lengthwise direction of the electrical connector housing.

12. The electrical connector housing of claim 9, wherein the passages in the two rows are partially merged.

13. The electrical connector housing of claim 9, wherein the plurality of cutting blades are made of metal.

14. The electrical connector housing of claim 9, wherein the plurality of cutting blades are integral with the contact blades correspondingly.

15. The electrical connector housing of claim 13, wherein the plurality of cutting blades are made of metal and coated with insulation material.

16. A method of making an electrical connector, comprising:
(a) providing an electrical connector housing that comprises a plurality of contact blades, each received in a groove formed in a top surface of the electrical connector housing; a plurality of passages formed inside the electrical connector housing and located below the plurality of contact blades, each passage communicating with a rear opening and extending through a front surface of the electrical connector housing; and a slot formed between the plurality of the contact blades and the front surface of the electrical connector housing, the slot extending perpendicularly from the top surface of the electrical connector housing to communicate with each of the plurality of passages;
(b) providing a tool having a cutting blade and a crimping portion;
(c) inserting each of a plurality of insulated wires from the rear opening of the electrical connector housing, and passing each wire through the corresponding passage to protrude beyond the slot; and
(d) concurrently pressing the contact blades of the electrical connector housing with the crimping portion of the tool and pressing the cutting blade of the tool into the slot of the electrical connector housing so that the contact blades of the electrical connector move downward and pierce through the insulated layers of the insulated wires to make electrical connections between the contact blades and the insulated wires, and the cutting blade moves downward to cut off the portions of the insulated wires that protrude beyond the slot.

17. A method of making an electrical connector, comprising:
(a) providing an electrical connector housing that comprises a plurality of contact blades, each received in a groove formed in a top surface of the electrical connector housing; a plurality of passages formed inside the electrical connector housing and located below the plurality of contact blades, each passage communicating with a rear opening and extending through a front surface of the electrical connector housing; a slot formed between the plurality of the contact blades and the front surface of the electrical connector housing, the slot extending perpendicularly from the top surface of the electrical connector housing to communicate with each of the plurality of passages; and a cutting blade received in the slot, wherein the cutting blade is movable in a first position in which a tip of the cutting blade is not in the plurality of the passages, and in a second position in which the tip of the cutting blade is in the plurality of the passages;
(b) inserting each of a plurality of insulated wires from the rear opening of the electrical connector housing, and passing each wire through the corresponding passage to protrude beyond the slot; and
(c) concurrently pressing the contact blades and the cutting blade of the electrical connector housing so that the contact blades move downward and pierce through the insulated layers of the insulated wires to make electrical connections between the contact blades and the insulated wires, and the cutting blade moves downward to cut off the portions of the insulated wires that protrude beyond the slot.

18. A method of making an electrical connector, comprising:
(a) providing an electrical connector housing that comprises a plurality of contact blades, each received in a groove formed in a top surface of the electrical connector housing; a plurality of passages formed inside the electrical connector housing and located below the plurality of contact blades, each passage communicating with a rear opening and extending through a front surface of the electrical connector housing; and a slot formed between the plurality of the contact blades and the front surface of the electrical connector housing, the slot extending perpendicularly from the top surface of the electrical connector housing to communicate with each of the plurality of passages, wherein the passages are arranged in a lower row and an upper row and are alternating in the two rows, and the slot comprises a plurality of thin slots, the electrical connector housing further comprising a plurality of cutting blades received in the thin slots, each positioned with the corresponding one of the passages, wherein the cutting blades are spaced apart from each other and are movable in a first position in which tips of the cutting blades are not in the plurality of the passages, and in a second position in which the tips of the cutting blade are in the plurality of the passages;
(b) inserting each of a plurality of insulated wires from the rear opening of the electrical connector housing, and passing each wire through the corresponding passage to protrude beyond the thin slots; and
(c) concurrently pressing the contact blades and the plurality of cutting blades of the electrical connector housing so that the contact blades move downward and pierce through the insulated layers of the insulated wires to make electrical connections between the contact blades and the insulated wires, and the plurality of cutting blades moves downward to correspondingly cut off the portions of the insulated wires that protrude beyond the thin slots.

19. The electrical connector housing of claim 6, wherein the cutting blade is a single cutting blade and is made of metal, hard plastic or ceramic that is sufficiently hard for cutting insulated wires.

20. The electrical connector housing of claim 14, wherein the plurality of cutting blades are made of metal and coated with insulation material.
